(19) United States
(12) Patent Application Publication
(10) Pub. No.: US 2012/0001728 A1
(43) Pub. Date: Jan. 5, 2012

(54) METHOD AND SYSTEM FOR DETERMINING LOCATION INFORMATION

(76) Inventor: Tom J. Janiszewski, Andover, NJ (US)

(21) Appl. No.: 12/826,760

(22) Filed: Jun. 30, 2010

(51) Int. Cl. G08B 5/22

(52) U.S. Cl. 340/8.1

(57) ABSTRACT

An exemplary location detector includes a receiver that is configured to receive a low power signal from a locating beacon and to receive a transmission from at least one other location detector. The location detector includes a processor that is configured to determine an identifier of the locating beacon from which the low power signal was received. The processor is also configured to determine any difference between a first signal strength of the at least one low power signal received by the receiver and a second signal strength of a low power signal received by at least one other location detector from the same locating beacon. The location detector also includes a transmitter configured to report the first signal strength and the determined identifier of the locating beacon responsive to the processor determining that the first signal strength is at least equal to the second signal strength.

### BACKGROUND

There are various situations in which locating an object or an individual is desirable. For example, in a hospital setting it is useful to be able to determine the location of particular equipment. There are a variety of commercial or industrial settings in which determining the location of equipment or individuals is also useful.

There are a variety of technologies available for determining locations of objects or individuals. Global positioning system (GPS) arrangements provide accurate location information for many situations. One significant shortcoming of GPS arrangements is that the GPS receivers require a clear view of the sky. Such arrangements are not useful within closed buildings or other settings where sufficient satellite signals are not readily received.

Another example location technology is based on cellular telecommunications equipment. Such arrangements have a similar limitation in that base station signals may not be available at all positions where location information is desired. Additionally, devices capable of cellular telecommunications may be too expensive for some applications.

It is known to use radio frequency (RF) tags such as WiFi tags for location purposes. One limitation on known systems is that the accuracy of a determined location is insufficient for some situations. For example, it may be possible to locate a WiFi tag within 5 or 10 meters. In order to achieve greater accuracy, the number of WiFi detectors has to be increased within an area of interest. Multiplying the number of WiFi detectors or access points can quickly become cost-prohibitive for many situations. Additionally, the backhaul requirements for the WiFi detectors may require additional hard-wiring, which introduces additional inconvenience and expense. One other limiting factor in this regard is that an increased density of WiFi detectors introduces an increased likelihood of interference that reduces channel utilization.

### SUMMARY

An exemplary location detector includes a receiver that is configured to receive a low power signal from a locating beacon and to receive a transmission from at least one other location detector. The location detector includes a processor that is configured to determine an identifier of the locating beacon from which the low power signal was received. The processor is also configured to determine any difference between a first signal strength of the at least one low power signal received by the receiver and a second signal strength of a low power signal received by at least one other location detector from the same locating beacon. The location detector also includes a transmitter configured to report the first signal strength and the determined identifier of the locating beacon responsive to the processor determining that the first signal strength is at least equal to the second signal strength.

An exemplary method of locating a low power beacon includes receiving a low power locating beacon signal at a location detector. The received signal includes an identifier of the locating beacon from which the locating beacon signal was received. The location detector determines a first signal strength of the received locating beacon signal. The location detector also receives a transmission from at least one other location detector that indicates a second signal strength of a locating beacon signal received by the at least one other location detector from the same locating beacon. The location detector determines any difference between the first signal strength and the second signal strength and reports the first signal strength and the determined identifier to a location determining module if the first signal strength is at least equal to the second signal strength.

An exemplary locating system includes a locating beacon that transmits a low power locating beacon signal, a plurality of location detectors and a location determining module. Each location detector includes a receiver that is configured to receive the low power locating beacon signal and to receive a transmission from at least one other location detector. The location detectors also have a processor that is configured to determine an identifier of the locating beacon and determine any difference between a first signal strength of the received low power locating beacon signal and a second signal strength of a low power signal received by at least one other location detector from the same locating beacon. Each location detector includes a transmitter configured to report the first signal strength and the determined identifier of the locating beacon responsive to the processor determining that the first signal strength is at least equal to the second signal strength. The location determining module is configured to receive the reported signal strength and to determine an at least approximate location of the locating beacon.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates a system for monitoring a location designed according to an embodiment of this invention.

FIG. 2 schematically illustrates selected portions of an example location detector useful in the example system of FIG. 1.

FIG. 3 is a flowchart diagram summarizing an example approach used by an example location detector.

FIG. 4 is a flowchart diagram summarizing an example approach used by an example location determining module.

### DETAILED DESCRIPTION

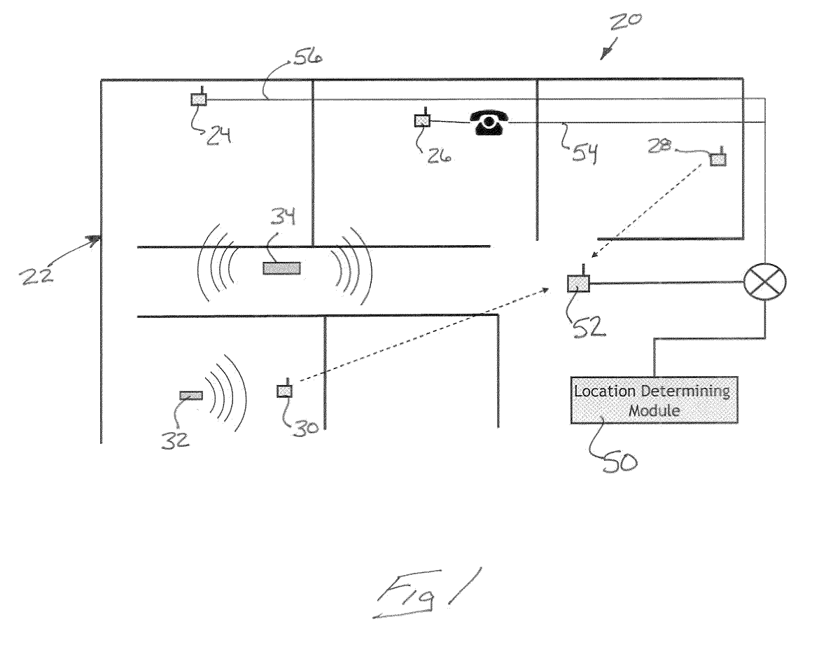

FIG. 1 schematically shows a system 20 for monitoring a site 22. A plurality of location detectors 24, 26, 28 and 30 are strategically positioned within the site 22. In this example, the site 22 is divided up into different areas of interest. In the illustrated example each detector is associated with a preselected one of the areas.

The site 22 may be a portion of a building such as a hospital floor having several rooms and hallways. Each of the areas schematically shown in FIG. 1 may represent a room or another portion of a location of interest. The site 22 may also be a particular geographic region within which location information is desired. The schematically shown areas do not necessarily correspond to rooms or other structural limitations on the site 22. In some examples, some rooms or areas may not have any detector within them while others may have multiple detectors.

The detectors 24-30 are configured to detect low power signals from transmitted by locating beacons 32 and 34, for example. As an individual moves through any of the areas of the site 22 carrying or wearing an appropriate transmitter device such as the locating beacon 32, the detectors 24-30 may receive signals from that locating beacon for purposes of providing location information. An object or device having the locating beacon 34 situated on it may be moveable within the site 22 into a variety of positions and the detectors 24-30 may detect signals from the locating beacon 34 for purposes of determining a location of the associated object or device.

One feature of the illustrated example is that the detectors 24-30 and the locating beacons 32 and 34 are low cost items. In one example, the locating beacons 32 and 34 comprise small, inexpensive transmitters. One example includes using low power transmissions to keep the expense of the monitoring system 20 at a minimum and to avoid signaling interference with the operation of other devices within the site 22. In one example, the detectors 24-30 and locating beacons 32, 34 are configured to operate in the 2.4 GHz band range. In one example, the locating beacons 32 and 34 transmit an ultra low power signal having a power of approximately 0 dBm.

Utilizing low power, low cost devices provides economic advantages compared to systems that relied upon higher power location beacons. One feature of the illustrated example is that lower cost detectors can be used that are capable of receiving and processing ultra low power signals.

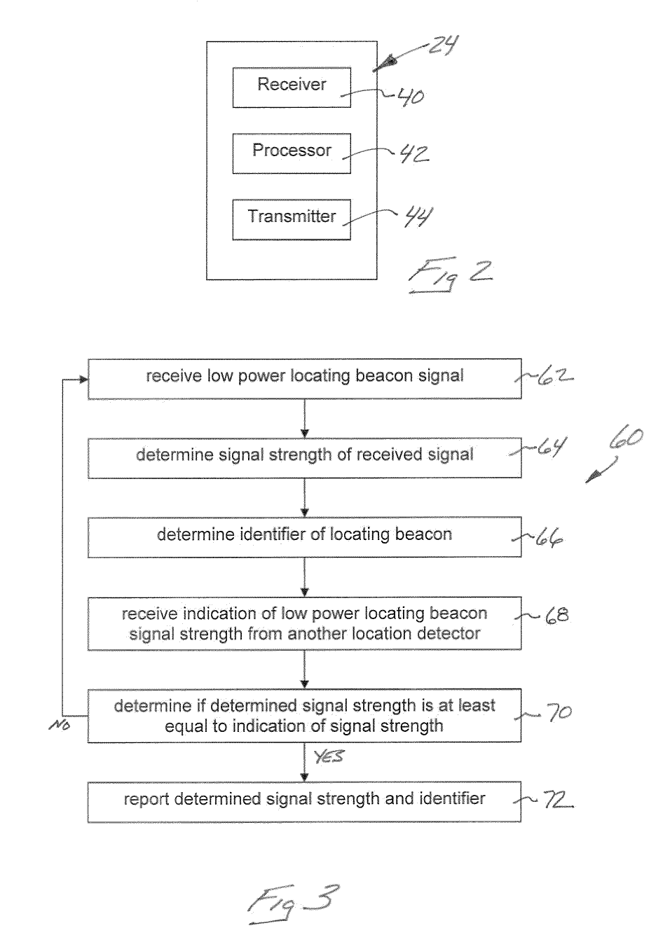

An example location detector 24 is schematically shown in FIG. 2. In this example all of the detectors 24-30 are essentially identical in form and function. The example detector 24 includes a receiver 40 that is configured to receive the ultra low power locating beacon signals from the locating beacons 32 and 34. The example detector 24 includes a processor 42 that is configured to process any received location beacon signal. The processor 42 determines an identifier of the locating beacon from which the location beacon signal was received and determines a signal strength of the received location beacon signal. In one example, known signal strength measurement techniques are used to determine a received signal strength indicator (RSSI).

The example location detector 24 of FIG. 2 also includes a transmitter 44 that reports the RSSI and the beacon identifier to a location determining module 50 that is part of the system 20 in FIG. 1. In some examples, the transmitter 44 communicates with a WiFi access node 52 that is situated in the site 22.

In the example of FIG. 1, the location detectors 30 and 28 are configured to communicate with the WiFi access node 52 as schematically shown. The WiFi access node 52 then communicates over an Ethernet or other backhaul connection to provide the reported RSSI and identifier to the location determining module 50. The detector 26 has a hardwired connection 54 and the detector 24 has a hardwired connection 56 for purposes of reporting the RSSI and identifier of a corresponding location beacon to the location determining module 50.

One feature of the illustrated example is that the detectors 24-30 determine whether a signal received from a locating beacon transmitter has a signal strength that exceeds a pre-selected threshold. If this received signal is too weak, then the locating beacon is probably too far away from that particular detector so that a report from that detector to the location determining module 50 will not provide useful information. If a received signal has a sufficient signal strength, then the detector 24-30 reports it to the location determining module 50. One example includes a strategy for controlling how many signal strength reports are provided to the location determining module 50.

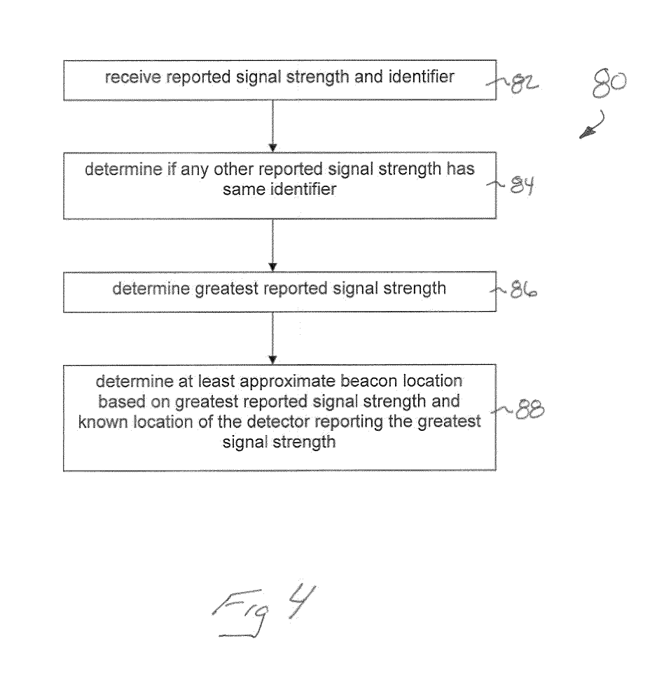

FIG. 3 includes a flowchart diagram 60 summarizing an example approach. Assume for the purposes of discussion that the detectors 24, 26 and 30 each receive a low power locating beacon signal from the locating beacon 34. Assume also that the detectors 24 and 30 receive a locating beacon signal from the locating beacon 32. This is shown at 62 in FIG. 3 where the low power locating beacon signal is received.

At 64, each detector determines the signal strength of the received signal or signals. At 66, the identifier of the locating beacon providing each signal received by each detector is determined by each detector. Assume for the purposes of discussion that each signal received by each detector exceeds the pre-selected threshold for signal strength so that the received signal is considered at least a candidate for being reported to the location determining module 50. If the received signal strength is below the threshold then the detector discards the signal without further processing.

Each detector 24-30 includes the receiver 40 that is also configured to receive signals from the other detectors nearby that detector. Each detector provides an indication of a received signal strength and a corresponding locating beacon identifier. At 68 in FIG. 3, each detector that has received a locating beacon signal will wait a preselected time during which the detector may receive at least one indication of a low power locating beacon signal strength and a corresponding identifier from another location detector. For example, the detector 24 will receive an indication from the detectors 26 and 30 regarding the corresponding received signal strength from the locating beacon 34. The detector 30 will also provide an indication regarding the received signal strength from the locating beacon 32. The detector 26 will receive similar signals or indications from the detectors 24 and 30. Likewise, the detector 30 will receive indications from the detectors 24 and 26 regarding their respectively received signal strengths and corresponding identifiers.

Each detector will take such a received indication and determine whether the identifier corresponds to an identifier of a locating beacon signal received directly by that detector. If the identifiers correspond, then the detector determines whether the signal strength of the locating beacon signal received directly by that detector is at least equal to the indication of received signal strength from the other location detector. This is shown at 70 in FIG. 3.

For example, the detector 30 will receive an indication from each of the detectors 24 and 26 regarding the received signal strength of the locating beacon signal from the locating beacon 34. Assume, for the purposes of discussion, that the detector 30 has the strongest received signal strength from the locating beacon 34. The determination made at 70 by the detector 30 would indicate that the determined signal strength is at least equal to the indication of signal strengths from the other two detectors. The detector 30 would then proceed to the step shown at 72 in FIG. 3 where the detector 30 will report the determined signal strength and the identifier of the locating beacon 34. That reported information can then be used by the location determining module 50 to determine an at least approximate location of the locating beacon 34.

Assume, for the purposes of discussion, that the signal received by the detector 24 from the locating beacon 34 has a lower strength compared to the signals received by the detectors 26 and 30 from the locating beacon 34. The detector 24 would determine, based on the indications from the detectors 26 and 30, that the received signal strength of the signal from the locating beacon 34 is less than the signal strength received by the other two detectors. The detector 24 in this instance will discard the received signal information and will not report it to the location determining module 50.

Assume further that the detector 24 determines that the received signal strength from the locating beacon 32 is less than the received signal strength indicated by the detector 30 for the same locating beacon. The detector 24 would not perform the step shown at 72 in FIG. 3, but instead would discard the signal information. The detector 24 would then return to the step at 62 and wait the arrival of another low power locating beacon signal.

The detector 26 will receive an indication from the detector 30 regarding each of the low power locating beacon signals received by the detector 30. The detector 26 can ignore the indication regarding the signal received from the locating beacon 32 because the detector 26 does not have a received signal with a corresponding identifier. The detector 26 will determine the relative strength of the signal received from the locating beacon 34 by the detector 26 and the detector 30 for purposes of determining whether the detector 26 will report the received signal strength to the location determining module 50.

This strategy allows for reducing the amount of signaling provided to the location determining module 50. Rather than requiring that module to receive a signal from every detector that receives any strength level signal from a locating beacon, the process of determining whether a detector will report such information reduces the computational requirements of the location determining module 50. Additionally, when wireless transmissions are used for reporting the RSSI and identifier information, reducing the number of times such reports are given provides for battery savings and allows for using lower cost components, for example.

FIG. 4 includes a flowchart diagram 80 that summaries an example approach used by an example location determining module 50. At 82, the reported signal strengths and identifiers are received from any detector that has determined that it should provide such a report. The location determining module 50 determines whether more than one detector has reported a signal strength for the same locating beacon identifier at 84. In one example, the location determining module 50 will receive a first reported signal strength and identifier from one of the detectors and then wait for a specified time period to see whether any other detectors report an RSSI for the locating beacon having the same identifier. At 86, the location determining module 50 determines the greatest reported signal strength for any particular locating beacon identifier. At 88, an at least approximate beacon location is determined based upon the greatest reported signal strength and the known location of the detector reporting that signal strength. In one example, when one reported signal strength is significantly higher than any others for that particular beacon, the beacon is determined to be in the area where the reporting detector is located.

Because the detectors 24-30 are configured to receive the ultra low power signals from the locating beacons 32 and 34, the detectors can be relatively inexpensive devices. This allows for strategically placing as many detectors as desired within the site 22. Each detector can have a known location that provides for a fairly accurate location determination regarding the position of any particular beacon from which a signal is received. In some examples, the location information can be accurate to within one meter.

Another feature of the disclosed example is that it allows for minimizing the amount of power used by each beacon transmission. By increasing the number of detectors, the transmission power required from each beacon may be reduced. This increases the battery life for a beacon and allows for increasing the frequency of locating beacon signals so that location information can be tracked at a finer granularity.

Another feature of reducing transmission power is that it minimizes interference with other networks because the ultra low power beacon transmissions will only be received by nearby detectors.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A location detector, comprising:
a receiver that is configured to receive a low power signal from a locating beacon and to receive a transmission from at least one other location detector;
a processor that is configured to
(i) determine an identifier of a locating beacon from which at least one low power signal was received by the receiver and
(ii) determine any difference between a first signal strength of the at least one low power signal received by the receiver and a second signal strength of a low power signal received by at least one other location detector from the locating beacon having the determined identifier; and
a transmitter configured to report the first signal strength and the determined identifier of the locating beacon responsive to the processor determining that the first signal strength is at least equal to the second signal strength.

2. The device of claim 1, wherein
the processor is configured to determine if any other location detector provides an indication of the second signal strength within a preselected time after the receiver receives the at least one low power signal; and
the transmitter reports the first signal strength and the determined identifier if no other location detector provides an indication of the second signal strength within the preselected time or the first signal strength is at least equal to any second signal strength indicated within the preselected time.

3. The device of claim 1, wherein
the transmitter provides an indication of the first signal strength and the determined identifier responsive to the receiver receiving the at least one low power signal, the indication being for reception by another location detector.

4. The device of claim 1, wherein
the processor is configured to determine when at least three other location detectors each provide an indication of respective second signal strengths; and
the transmitter reports the first signal strength and the determined identifier if the first signal strength is at least equal to all of the at least three second signal strengths.

5. The device of claim 1, wherein the receiver is configured to receive the low power signal having an approximately 0 dBm power level.

6. A method of locating a low power beacon, comprising the steps of:
receiving a low power locating beacon signal at a location detector;
determining an identifier of a locating beacon from which the locating beacon signal was received
determining a first signal strength of the received locating beacon signal;
receiving a transmission from at least one other location detector that indicates a second signal strength of a locating beacon signal received by the at least one other location detector from the locating beacon having the determined identifier;
determining any difference between the first signal strength and the second signal strength; and
reporting the first signal strength and the determined identifier to a location determining module if the first signal strength is at least equal to the second signal strength.

7. The method of claim 6, comprising
determining if any other location detector device provides an indication of the second signal strength within a preselected time after receiving the low power locating beacon signal; and
reporting the first signal strength and the determined identifier if no other location detector provides an indication of the second signal strength within the preselected time or the first signal strength is at least equal to any second signal strength indicated within the preselected time.

8. The method of claim 6, comprising
providing an indication of the first signal strength and the determined identifier responsive to receiving the low power beacon signal, the indication being for reception by another location detector.

9. The method of claim 6, comprising
determining when at least three other location detectors each provide an indication of respective second signal strengths to the location detector; and
reporting the first signal strength and the determined identifier if the first signal strength is at least equal to all of the at least three second signal strengths.

10. The method of claim 6, wherein low power beacon signal has an approximately 0 dBm power level.

11. The method of claim 6, comprising
receiving the reported first signal strength and the identifier at a location determining module;
determining a location of the low power beacon based on the first signal strength and a known location of the location detector.

12. The method of claim 6, comprising
receiving the reported first signal strength and the identifier at a location determining module;
receiving a reported second signal strength and the identifier at the location determining module;
determining any difference between the reported first signal strength and the reported second signal strength; and
determining a location of the low power beacon using the greater of the reported first signal strength or second signal strength and a known location of the location detector that reported the greater signal strength.

13. A locating system, comprising:
a locating beacon that transmits a low power locating beacon signal;
a plurality of location detectors each including
a receiver that is configured to receive the low power locating beacon signal and to receive a transmission from at least one other location detector;
a processor that is configured to
(i) determine an identifier of the locating beacon and
(ii) determine any difference between a first signal strength of the received low power locating beacon signal and a second signal strength of a low power signal received by at least one other location detector from the locating beacon having the determined identifier; and
a transmitter configured to report the first signal strength and the determined identifier of the locating beacon responsive to the processor determining that the first signal strength is at least equal to the second signal strength; and
a location determining module configured to receive the reported signal strength and to determine an at least approximate location of the locating beacon.

14. The system of claim 13, wherein
each location detector processor is configured to determine if any other location detector provides an indication of the second signal strength within a preselected time after the receiver receives the at least one low power signal; and
each location detector transmitter reports the first signal strength and the determined identifier to the location determining module if no other location detector provides an indication of the second signal strength within the preselected time or the first signal strength is at least equal to any second signal strength indicated within the preselected time.

15. The system of claim 12, wherein
each location detector transmitter provides an indication of the first signal strength and the determined identifier responsive to the receiver receiving the at least one low power signal, the indication being for reception by another one of the location detectors.

16. The system of claim 1, wherein
each location detector processor is configured to determine when at least three other location detectors each provide an indication of respective second signal strengths; and
the transmitter reports the first signal strength and the determined identifier if the first signal strength is at least equal to all of the at least three second signal strengths.

17. The system of claim 13, wherein the location determining module
receives the reported first signal strength and the identifier; and
determines the at least approximate location of the low power beacon based on the first signal strength and a known location of the location detector from which the reported first signal strength was received.

18. The system of claim 13, wherein the location determining module
receives the reported first signal strength and the identifier from a first one of the location detectors;
receives a reported second signal strength and the identifier from a second one of the location detectors;
determines any difference between the reported first signal strength and the reported second signal strength; and
determines the at least approximate location of the low power beacon using the greater of the reported first signal strength or second signal strength and a known location of the location detector that reported the greater signal strength.

19. The system of claim 1, wherein the low power locating beacon signal has an approximately 0 dBm power level.
